(19) United States
(12) Patent Application Publication
(10) Pub. No.: US 2026/0087584 A1
(43) Pub. Date: Mar. 26, 2026

(54) Tiled Minimal Latency Content Update

(71) Applicant: Apple Inc., Cupertino, CA (US)

(72) Inventors: Peter A. Lisherness, Los Gatos, CA (US); Mahesh B. Chappalli, San Jose, CA (US); Davoud A. Jamshidi, San Jose, CA (US)

(21) Appl. No.: 19/055,477

(22) Filed: Feb. 17, 2025

Related U.S. Application Data
(60) Provisional application No. 63/699,707, filed on Sep. 26, 2024.

(51) Int. Cl. G06T 1/20

(52) U.S. Cl. CPC G06T 1/20

(57) ABSTRACT

Systems, methods, and devices are provided to reduce latency in displaying image data on an electronic display. This may include instructing image processing circuitry to read a first tile of image data from a first framebuffer, determining whether the first framebuffer or a second framebuffer has a more recent second tile after the first tile and, based on whether the first framebuffer or the second framebuffer has the more recent second tile, instructing the image processing circuitry to read the second tile from the first framebuffer or the second framebuffer that has the more recent second tile.

### CROSS-REFERENCE TO RELATED APPLICATIONS

This application claims priority to U.S. Provisional Application No. 63/699,707, filed Sep. 26, 2024, which is incorporated by reference herein in its entirety.

### BACKGROUND

This disclosure is directed to systems and methods for rapidly rendering and displaying graphics with tile granularity based on a recency of a next tile or tile row in a framebuffer.

A computer display controller may wait for a full frame of new image content (e.g., image data) to be fully written before displaying the frame at the next “vsync”, or frame boundary. The term “vsync,” may refer to vertical synchronization—a setting that, when activated, enables the display controller to wait for an entire frame of image data to be fully generated before switching over to the fully-loaded frame for display (e.g., synchronizes the frame output with the display's refresh rate). As a result, a user may experience latency, or a delay, between the time a gram is generated and the time it is actually displayed on the screen. Some computer users, particularly gamers who notice a competitive benefit to faster game content rendering, may prefer to minimize latency by controlling certain display settings that may reduce latency by aligning frame output with display refresh rates. For example, by disabling “vsync,” the display controller may switch from displaying current image data to displaying new image data mid-frame, or before the current frame is fully loaded. This may create a “tearing” effect known as “screen tearing,” which may appear as a horizontal “rip” or “tear” in the displayed image content. Although disabling “vsync” may reduce latency, the entire current frame is at least rendered before the display controller switches to the new frame.

### SUMMARY

Some GPUs may render the frame as a series of image data tiles smaller than the full frame the display controller consumes. These tiles are completed in an arbitrary order and at arbitrary times. Rendering image data with tile granularity (e.g., on a tile-by-tile basis) may further minimize latency compared to traditional whole-frame rendering. Embodiments disclosed herein are directed to a connection between the GPU and the display controller, which allows the GPU to indicate which tiles of the next frame have completed rendering. The display controller may then decide on a tile-by-tile basis or a tile row-by-tile row basis whether to fetch from one framebuffer or another. In this way, completed tiles do not have to wait for the rest of the frame to complete before they are displayed, thereby reducing the latency beyond that offered by full-frame vsync-off. As a result, a new visual artifact may be created that is different from the “screen tearing” typically seen with vsync-off. This new visual artifact may provide a “signature look” that represents that a user is getting a very low latency (potentially even the lowest possible latency).

### BRIEF DESCRIPTION OF THE DRAWINGS

Various aspects of this disclosure may be better understood upon reading the following detailed description and upon reference to the drawings in which:

FIG. 1 is a schematic diagram of an electronic device that includes an electronic display, in accordance with an embodiment;

FIG. 2 is an example of the electronic device of FIG. 1 in the form of a handheld device, in accordance with an embodiment;

FIG. 3 is another example of the electronic device of FIG. 1 in the form of a tablet device, in accordance with an embodiment;

FIG. 4 is another example of the electronic device of FIG. 1 in the form of a computer, in accordance with an embodiment;

FIG. 5 is another example of the electronic device of FIG. 1 in the form of a watch, in accordance with an embodiment;

FIG. 6 is another example of the electronic device of FIG. 1 in the form of a headset, in accordance with an embodiment;

FIG. 7 is a block diagram of a system for displaying image content on an electronic device via a double framebuffer, in accordance with an embodiment;

FIG. 8 is a flowchart of an example process for displaying image content on a tile-by-tile basis via a multi-framebuffer system, in accordance with an embodiment;

FIG. 9 is a block diagram of a first tile of image content being read by image data for display on an electronic device on a tile-by-tile basis, in accordance with an embodiment;

FIG. 10 is a block diagram of a first tile of image content being read by image data for display on an electronic device on a tile-by-tile basis, in accordance with an embodiment; and

FIG. 11 is a block diagram of a first tile of image content being read by image data for display on a tile-by-tile basis, in accordance with an embodiment.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

Electronic devices often use electronic displays to present visual information or image content. Examples of such electronic devices may include computers, mobile phones, portable media devices, tablets, televisions, virtual-reality headsets, and vehicle dashboards, among many others. Such electronic devices may have a display controller, display engine, display interface, or the like that may operate to turn digital display data into the image content viewed by a user on the display. Additionally, such electronic devices may have a framebuffer (e.g., a framestore), that may operate as a type of memory to hold the image data associated with the image content to be displayed on the electronic display. As a user interacts with the electronic device, new image data may be generated. The GPU may generate, update, and store the new image data via one or more framebuffers until the image data is displayed via the display controller.

As used herein, “minimal latency” refers to a reduced latency that, in some cases, may be the smallest delay possible when transmitting image data between a source (e.g., a framebuffer) and a destination (e.g., an electronic display). Latency is often measured in milliseconds and may vary depending on the image content application. For example, latency in the context of web browsing may be longer versus latency in the context of real-time communication or online gaming without apparent advantages or disadvantages to the user. Embodiments disclosed herein are directed to a connection between the GPU and the display controller that may allow the controller to indicate to the display which tiles of the next frame to display based on an indication from the GPU regarding which tiles have completed rendering even before the current frame has entirely rendered, thereby achieving reduced (e.g., minimal) latency.

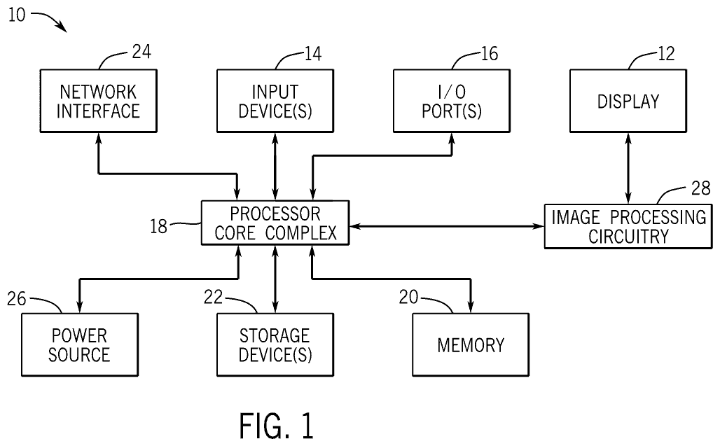

With the foregoing in mind, FIG. 1 is an example electronic device 10 with an electronic display 12 that may display image content for viewing by a user. As described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is merely one example of a particular implementation and is intended to illustrate the types of components that may be present in an electronic device 10.

The electronic device 10 may include one or more electronic displays 12, input devices 14, input/output (I/O) ports 16, a processor core complex 18 having one or more processors or processor cores, local memory 20, a main memory storage device 22, a network interface 24, a power source 26, and image processing circuitry 28. The various components described in FIG. 1 may include hardware elements (e.g., circuitry), software elements (e.g., a tangible, non-transitory computer-readable medium storing instructions), or a combination of both hardware and software elements. As should be appreciated, the various components may be combined into fewer components or separated into additional components. For example, the local memory 20 and the main memory storage device 22 may be included in a single component. Moreover, the image processing circuitry 28 (e.g., a GPU, a display image processing pipeline, a display controller, etc.) may be included in the processor core complex 18, the electronic display 12, or implemented separately. Although not shown, in another embodiment, the GPU may be implemented separately or as part of the image processing circuitry 28. In another embodiment, the GPU may be part of the processor core complex 18.

The processor core complex 18 is operably coupled with local memory 20 and the main memory storage device 22. Thus, the processor core complex 18 may execute instructions stored in local memory 20 or the main memory storage device 22 to perform operations, such as generating or transmitting image data to display on the electronic display 12. As such, the processor core complex 18 may include one or more general purpose microprocessors, one or more application specific integrated circuits (ASICs), one or more field programmable logic arrays (FPGAs), or any combination thereof.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a BLUETOOTH® network, a local area network (LAN), such as an 802.11x Wi-Fi network, or a wide area network (WAN), such as a 4G, Long-Term Evolution (LTE), or 5G cellular network.

The power source 26 may provide electrical power to operate the processor core complex 18 and/or other components in the electronic device 10. Thus, the power source 26 may include any suitable source of energy, such as a rechargeable lithium polymer (Li-poly) battery and/or an alternating current (AC) power converter.

The I/O ports 16 may enable the electronic device 10 to interface with various other electronic devices. The input devices 14 may enable a user to interact with the electronic device 10. For example, the input devices 14 may include buttons, keyboards, mice, trackpads, and the like. Additionally or alternatively, the electronic display 12 may include touch sensing components that enable user inputs to the electronic device 10 by detecting occurrence and/or position of an object touching its screen (e.g., surface of the electronic display 12).

The electronic display 12 may display a graphical user interface (GUI) (e.g., of an operating system or computer program), an application interface, text, a still image, and/or video content. The electronic display 12 may include a display panel with one or more display pixels to facilitate displaying images. Additionally, each display pixel may represent one of the sub-pixels that control the luminance of a color component (e.g., red, green, or blue). As used herein, each display pixel corresponds to one sub-pixel (e.g., a red, green, or blue subpixel).

As described above, the electronic display 12 may display an image by controlling the luminance output (e.g., light emission) of the sub-pixels based on corresponding image data. In some embodiments, pixel or image data may be generated by or received from an image source, such as the processor core complex 18, a graphics processing unit (GPU), storage device 22, or an image sensor (e.g., camera). Additionally, in some embodiments, image data may be received from another electronic device 10, for example, via the network interface 24 and/or an I/O port 16. Moreover, in some embodiments, the electronic device 10 may include multiple electronic displays 12 and/or may perform image processing (e.g., via the image processing circuitry 28) for one or more external electronic displays 12, such as connected via the network interface 24 and/or the I/O ports 16.

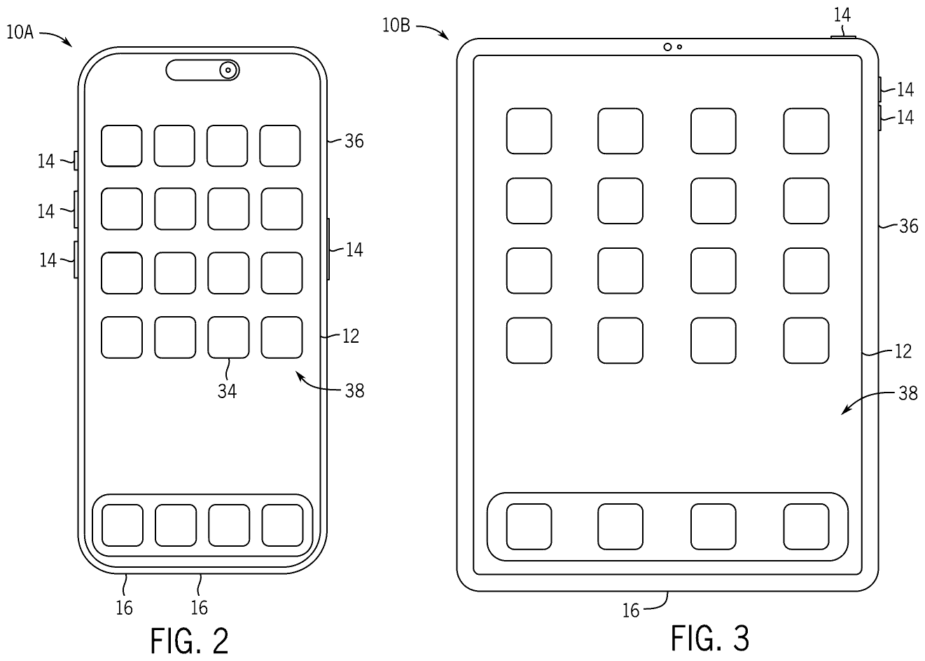

The electronic device 10 may be any suitable electronic device. To help illustrate, one example of a suitable electronic device 10, specifically a handheld device 10A, is shown in FIG. 2. In some embodiments, the handheld device 10A may be a portable phone, a media player, a personal data organizer, a handheld game platform, and/or the like. For illustrative purposes, the handheld device 10A may be a smartphone, such as an IPHONE® model available from Apple Inc.

The handheld device 10A may include an enclosure 30 (e.g., housing) to, for example, protect interior components from physical damage and/or shield them from electromagnetic interference. The enclosure 30 may surround, at least partially, the electronic display 12. In the depicted embodiment, the electronic display 12 is displaying a graphical user interface (GUI) 32 having an array of icons 34. By way of example, when an icon 34 is selected either by an input device 14 or a touch-sensing component of the electronic display 12, an application program may launch.

Input devices 14 may be accessed through openings in the enclosure 30. Moreover, the input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, and/or toggle between vibrate and ring modes. Moreover, the I/O ports 16 may also open through the enclosure 30. Additionally, the electronic device may include one or more cameras 36 to capture pictures or video. In some embodiments, a camera 36 may be used in conjunction with a virtual reality or augmented reality visualization on the electronic display 12. Another example of a suitable electronic device 10, specifically a tablet device 10B, is shown in FIG. 3. For illustration purposes, the tablet device 10B may be any IPAD® model available from Apple Inc.

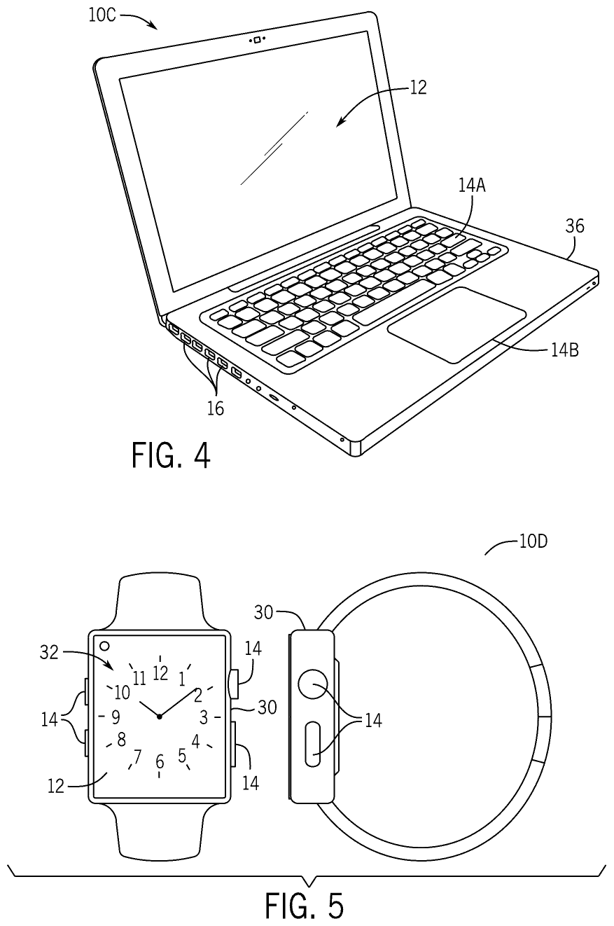

A further example of a suitable electronic device 10, specifically a computer 10C, is shown in FIG. 4. The computer 10C may be any suitable computer, such as a desktop computer, a server, a laptop computer, or a notebook computer, but may also be a standalone media player or video gaming machine. By way of example, the computer 10C may be an IMAC®, a MACBOOK®, or other similar device by Apple Inc. of Cupertino, California. It should be noted that the computer 10C may also represent a personal computer (PC) by another manufacturer. A similar enclosure 30 may be provided to protect and enclose internal components of the computer 10C, such as the electronic display 12. In certain embodiments, a user of the computer 10C may interact with the computer 10C using various peripheral input devices 14, such as a keyboard 14A or a mouse or touchpad 14B, which may connect to the computer 10C.

Another example of a suitable electronic device 10, specifically a watch 10D, is shown in FIG. 5. For illustrative purposes, the watch 10D may be an APPLE WATCH® model available from Apple Inc. As depicted, the tablet device 10B, the computer 10C, and the watch 10D each also includes an electronic display 12, input devices 14, I/O ports 16, and an enclosure 30. The electronic display 12 may display a GUI 32. In FIG. 5, the GUI 32 shows a visualization of a clock. When the visualization is selected either by the input device 14 or a touch-sensing component of the electronic display 12, an application program may launch, such as to transition the GUI 32 to presenting the icons discussed in FIGS. 2 and 3.

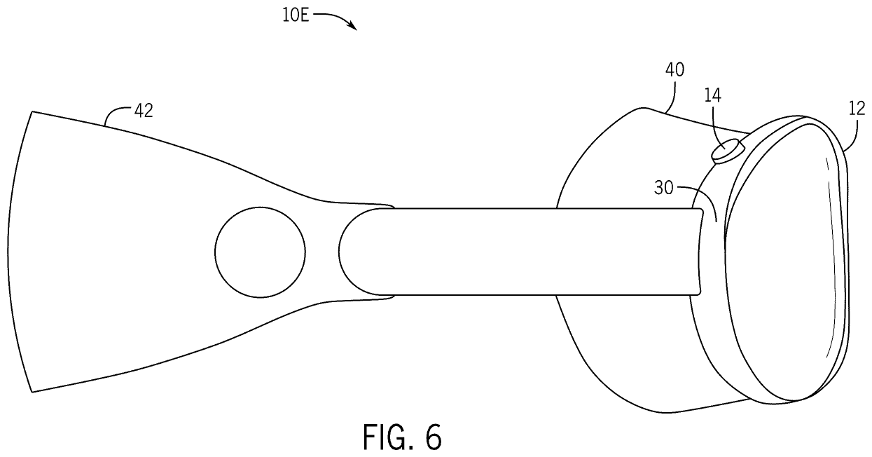

A further example of a suitable electronic device 10, specifically a virtual-reality headset 10E, is shown in FIG. 6. For illustrative purposes, the headset 10E may be an APPLE VISION PRO® model available from Apple Inc. As with the above examples of an electronic device 10A-10D, the headset 10E may also include an electronic display 12, input devices 14, I/O ports 16, and an enclosure 30. Additionally, the headset 10E may include a light seal 40 and/or a band 42 to fasten the device on a user's head.

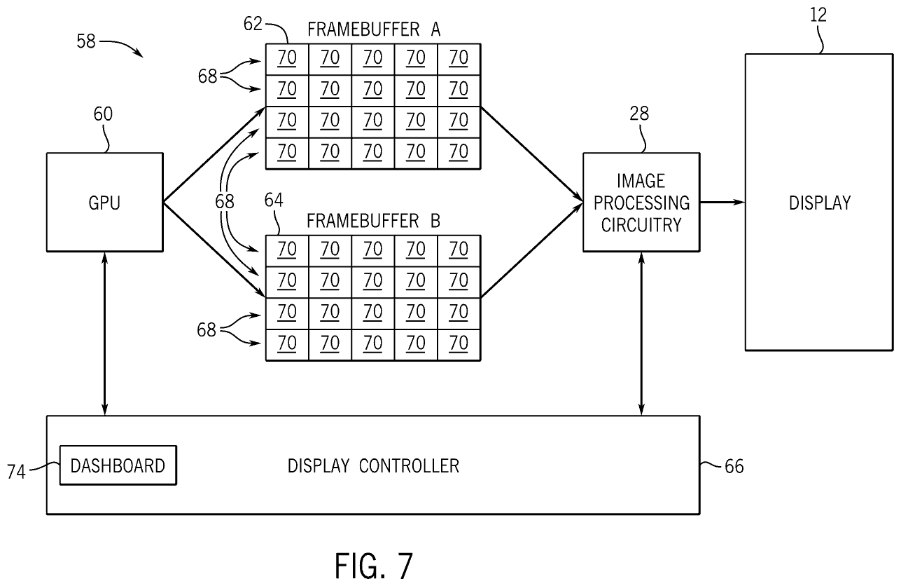

To help illustrate how latency may be reduced (e.g., minimized) via tile-based rendering, FIG. 7 shows an overview of a data processing system 58 for displaying image content on an electronic device via a double framebuffer. It should be noted that, although FIG. 7 shows a double-framebuffer system, the system may include any suitable number of framebuffers. Each framebuffer 62, 64 may be a component or a region in the system memory 20 that stores tiles 70 of image data for display. Each framebuffer 62, 64 may include multiple tile rows 68, and each tile row 68 may include multiple such tiles 70. The tiles 70 of image data may be generated by a graphic processing unit (GPU) and may correspond to a portion of one frame of image content. The GPU 60 may be communicatively coupled to a display controller 66 and may generate the tiles 70 of image data and write the tiles 70 into memory (e.g., into one of the framebuffers 62, 64) based on communication from the controller 66. The tiles 70, when generated by the GPU, may include compressed image data that can be decompressed and displayed. For example, although not shown, the tiles 70 may include multiple lines of compressed image data made up of pixels for the region of the tile. The image processing circuitry 28 may be communicatively coupled to the display controller 66 and may ready each tile 70 in the tile row 68 based on communication with the controller 66. For example, each tile 70 may be read one at a time (e.g. on a tile-by-tile basis), as it may be more efficient to encode a whole tile of pixels at one time compared to a whole line of pixels across multiple tiles in a row (e.g., on a line-by-line basis). When the tiles 70 are later read from one of the framebuffers 62, 64, they may be decompressed and displayed.

The display controller 66 may receive an indication from the GPU 60 as the GPU 60 writes tiles 70 into memory as they are generated. As the GPU 60 generates and writes new tiles 70, it may communicate to the display controller 66 an indication of the most recently generated tile 70 and/or may provide a recency associated with each tile 70 (e.g., a timestamp, a frame number). In some cases, the display controller 66 may use a dashboard 74 (e.g., written to by the GPU 60) to track which of the tiles 70 are new and which are old. In other cases, the tiles 70 may be associated with bits of memory that indicate whether the tiles 70 are marked as valid or invalid. For instance, the GPU 60 or the display controller 66 may mark new tiles 70 as valid as they are written into one of the framebuffers 62, 64. In one example, the GPU 60 may fill one of the framebuffers 62, 64 with new tiles 70, which may be marked as new in the dashboard 74 or in framebuffer memory using valid bits. The GPU 60 may write the new tiles 70 to the framebuffer 62 or 64 in any order (e.g., an arbitrary order, raster order). Once the GPU 60 finishes writing all the new tiles 70 corresponding to one frame to the framebuffer 62 or 64, the GPU 60 may switch to writing new tiles 70 corresponding to the next frame to the other framebuffer 64 or 62. This may be marked by the GPU 60 or the display controller 66 in the dashboard 74 or via the valid bits. For example, the tiles 70 of the “old” framebuffer 62 or 64 that the GPU 60 is no longer writing to may be marked as invalid. Meanwhile, the new tiles 70 that are being written by the GPU 60 into the “new” framebuffer 64 or 62 may be marked as new or valid as they are written.

The display controller 66, which may be communicatively coupled to the image processing circuitry 28, may control which framebuffer 62, 64 the image processing circuitry 28 reads from based on the indication from the GPU 60 (e.g., via the dashboard 74, by checking the valid bits). The indication from the GPU 60 may include information such as which framebuffer 62, 64 and tile row 68 the new tile 70 is written or stored in and, therefore, which framebuffer 62, 64 the image processing circuitry 28 should read from. In this way, the controller 66 may cause the image processing circuitry 28 to read from the tile row 68 in the framebuffer 62, 64 with the most recently generated tile 70. Additionally or alternatively, in some embodiments, the framebuffer 62, 64 may be read by the display controller 66.

The image processing circuitry 28 may include a display pipeline that prepares images data for display on the display 12. The image processing circuitry 28 may read and extract each tile 70 in the indicated tile row 68 that is ready to be read or may read one tile 70 at a time from whichever framebuffer 62, 64 has the newest next tile 70. By way of example, each tile 70 in the tile row 68 containing the most recently generated tile(s) 70 may be read in raster order. It is possible, therefore, that the tiles 70 read by the image processing circuitry 28 may result in a row being displayed on the display 12 based on tiles 70 that correspond to two (or more) different frames of image content. As a result, a new visual artifact may be created that is different from the “screen tearing” typically seen with vsync-off. This new visual artifact may provide a “signature look”that represents that a user is getting very low latency (e.g., the lowest possible latency).

When the image processing circuitry 28 reads the tile 70 from the framebuffer 62, 64, it may do so by extracting the compressed image data and decompressing it prior to sending it to the display panel 12. As previously mentioned, the tiles 70 may be read into the image processing circuitry 28 in raster order, and, as such, the image data may be presented on the display 12 in raster order.

To explain further, in one embodiment, the GPU 60 may write into a particular framebuffer 62, 64. The GPU 60 may write tiles 70 into the framebuffer 62, 64 one framebuffer 62, 64 at a time, filling the framebuffer 62, 64 with tiles 70 corresponding to a particular image frame. But because the GPU 60 may be capable of generating frames faster than the display 12 can display them, the GPU 60 may begin writing to the next framebuffer 64, 62 as soon as it has filled the previous framebuffer 62, 64. In this way, the GPU 60 may sometimes, but not always, write tiles 70 into an idle framebuffer 62, 64. The term “idle framebuffer” may refer to the framebuffer 62, 64 that is not currently being read by the display controller 66. Indeed, in some cases, the GPU 60 may write new tiles 70 into the framebuffer 62, 64 that is currently being read, which may be referred to as an “active framebuffer.” The term “active framebuffer” may refer to the framebuffer 62, 64 that is currently being read by the image processing circuitry 28 to render the image data onto the display screen.

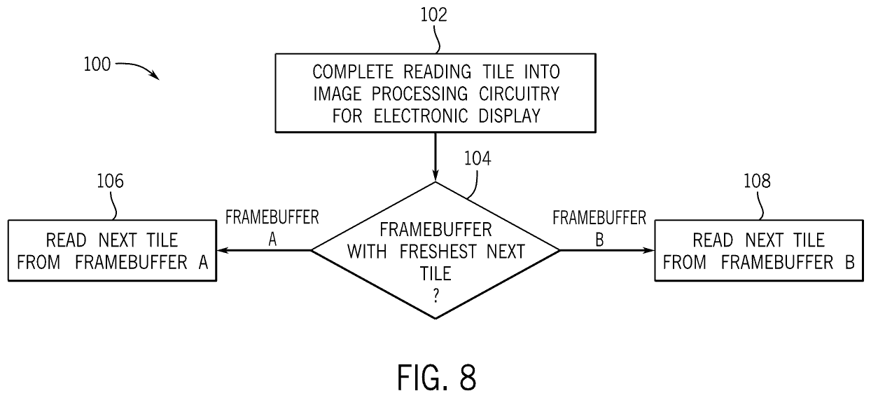

To further illustrate how the data processing system 58 of FIG. 7 may reduce latency, FIG. 8 provides an example process 100 for displaying image content on a tile-by-tile basis or tile row-by-tile row basis via a multi-framebuffer system. For example, a first tile of image data may be read from one of the framebuffers of the multi-framebuffer system (e.g., Framebuffer A 62) into the image processing circuitry for display on the electronic display (block 102). The display controller may determine which framebuffer of the multi-framebuffer system (e.g., Framebuffer A 62 or Framebuffer B 64) has a more recent tile corresponding to a next tile (e.g., a second tile in raster order after the first tile) (decision block 104). For example, the display controller may identify which framebuffer has the freshest version of the next tile based on the dashboard or valid bits of the framebuffers. When the framebuffer A 62 has the freshest next tile, the display controller may instruct the image processing circuitry to read the next tile from the Framebuffer A 62 (block 106). When the framebuffer B 64 has the freshest next tile, the display controller may instruct the image processing circuitry to read the next tile from the Framebuffer B 64 (block 108). In another example, entire tile rows may be read rather than individual tiles. For example, the next tile row in raster order may be selected to be read from either the Framebuffer A 62 or the Framebuffer B 64 based on which framebuffer has the newest tile in that tile row.

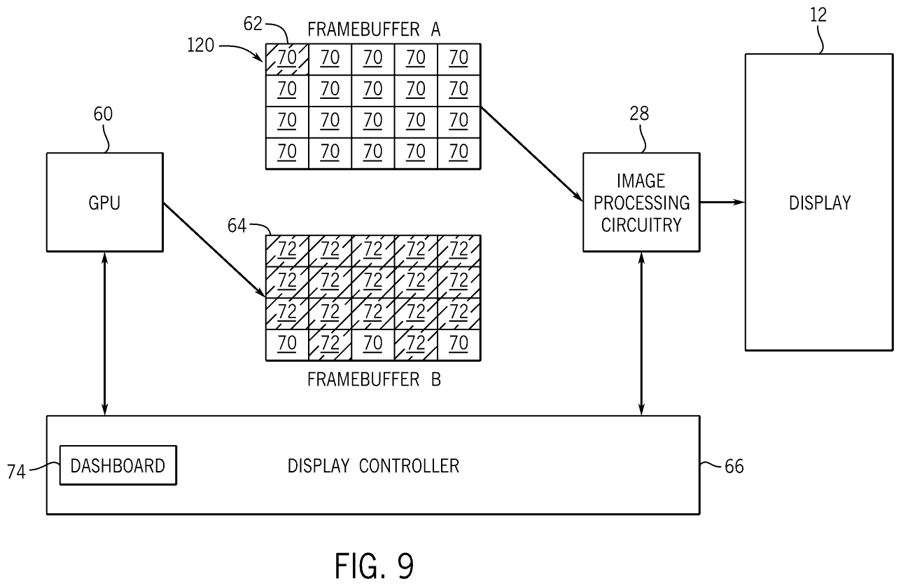

FIG. 9 illustrates a block diagram of an example embodiment of the above-described process 100 for displaying image content on an electronic device on a tile-by-tile basis. In the example of FIG. 9-11, the tiles 70 correspond to an older frame of image content and tiles 72 correspond to a newest frame of image content, which may be a second frame after the first frame, or may be a third frame, fourth frame, fifth frame, and so forth, depending on the rendering frame rate of the GPU 60. In the example of FIG. 9, a tile 70 (labeled as a first tile 120) may be read by the image processing circuitry 28 from the Framebuffer A 62 based on an instruction by the display controller 66. Meanwhile, the GPU 60 is writing a frame of new tiles 72 corresponding to a second frame into the Framebuffer B 64.

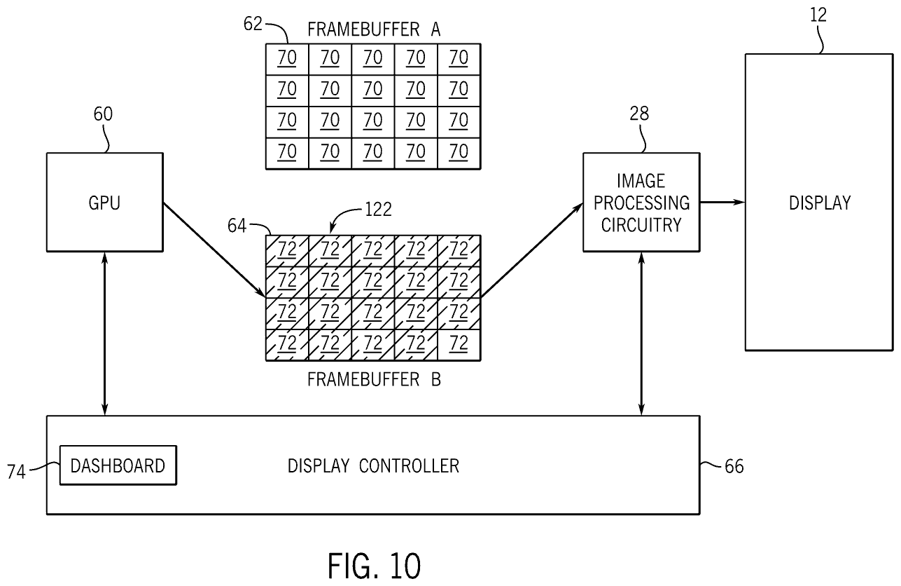

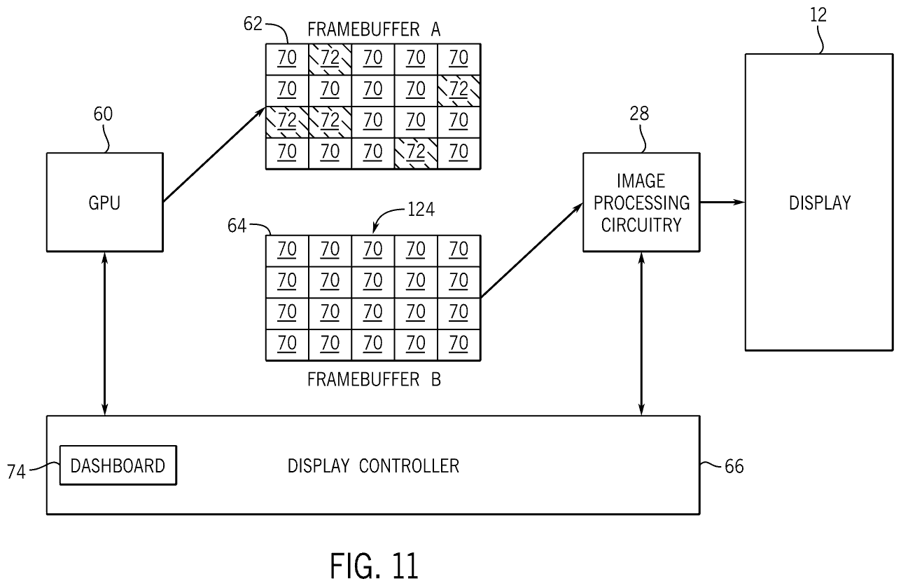

When the first tile 120 has been read, the image processing circuitry 28 may read the next tile in raster order from the first tile 120 in whichever framebuffer 62, 64 that holds the freshest tile in that position. As shown in FIG. 9, that is in Framebuffer B 64. As such, as shown in FIG. 10, the display controller 66 may instruct the image processing circuitry 28 to read a second tile 122 from the Framebuffer B 64, which holds image data corresponding to a second image frame. What is more, reading the second tile 122 from the Framebuffer B 64 may take place even while the GPU 60 completes writing the rest of the tiles of second frame to the Framebuffer B 64. Continuing with this example, in FIG. 11, the GPU 60 may begin writing new tiles corresponding to a third frame into the Framebuffer A 62. Meanwhile, the display controller 66 may instruct the image processing circuitry 28 to continue to read from the Framebuffer B 64 to obtain a third tile 124 as the next tile in raster order from the second tile 122 because Framebuffer B 64 still holds the freshest version of that tile. This process may continue, allowing a user to view image data as soon as possible without a tearing effect.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

It is well understood that the use of personally identifiable information should follow privacy policies and practices that are generally recognized as meeting or exceeding industry or governmental requirements for maintaining the privacy of users. In particular, personally identifiable information data should be managed and handled so as to reduce risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . .” or “step for [perform]ing [a function]. . .”, it is intended that such elements are to be interpreted under 35 U.S.C. 112(f). However, for any claims containing elements designated in any other manner, it is intended that such elements are not to be interpreted under 35 U.S.C. 112(f).

1. An article of manufacture comprising tangible, non-transitory, machine-readable media comprising instructions that, when executed by a data processing system, cause the data processing system to carry out operations comprising:
instructing image processing circuitry to read a first tile of image data from a first framebuffer;
determining whether the first framebuffer or a second framebuffer has a more recent second tile after the first tile; and
based on whether the first framebuffer or the second framebuffer has the more recent second tile, instructing the image processing circuitry to read the second tile from the first framebuffer or the second framebuffer that has the more recent second tile.

2. The article of manufacture of claim 1, wherein determining whether the first framebuffer or the second framebuffer has the more recent second tile comprises receiving an indication identifying the most recent tile from a graphics processing unit (GPU).

3. The article of manufacture of claim 1, wherein determining whether the first framebuffer or the second framebuffer has the more recent second tile comprises reading a dashboard of tile completion indicating a recency of tiles stored into the first framebuffer and the second framebuffer.

4. The article of manufacture of claim 1, wherein determining whether the first framebuffer or the second framebuffer has the more recent second tile comprises inspecting contents of the first framebuffer or the second framebuffer to identify whether there is valid data corresponding to the second tile available.

5. The article of manufacture of claim 4, wherein the operations comprise marking old tiles from whichever of the first framebuffer and the second framebuffer is not presently being written into as invalid and marking new tiles as valid as they are written into whichever of the first framebuffer and the second framebuffer is presently being written into.

6. The article of manufacture of claim 4, wherein the operations comprise marking new tiles with a timestamp as they are written into whichever of the first framebuffer and the second framebuffer is presently being written into.

7. The article of manufacture of claim 4, wherein the operations comprise setting a counter based on an arrival of new tiles as they are written into whichever of the first framebuffer and the second framebuffer is presently being written into.

8. The article of manufacture of claim 1, wherein the second tile is immediately after the first tile in raster order.

9. The article of manufacture of claim 1, wherein the second tile is part of the same tile row as the first tile.

10. The article of manufacture of claim 1, wherein the first tile and the second tile comprise compressed image data.

11. An electronic device comprising:
a graphics processing unit (GPU) configured to generate tiles of image data;
a plurality of framebuffers configured to store the tiles; and
an electronic display configured to display image data from one or more of the tiles stored in a selected one of the plurality of framebuffers based on which framebuffer of the plurality of framebuffers has a most recent tile.

12. The electronic device of claim 11, wherein the tiles of image data are compressed when generated.

13. The electronic device of claim 11, comprising image processing circuitry configured to read the selected one of the plurality of framebuffers.

14. The electronic device of claim 13, wherein the image processing circuitry is configured to decompress the tiles of image data.

15. The electronic device of claim 11, comprising a processor configured to run a display controller configured to control which of the plurality of framebuffers supplies the one or more of the tiles for display on the electronic display.

16. The electronic device of claim 15, wherein the display controller is configured to identify a tile or a row of tiles comprising the most recent tile.

17. The electronic device of claim 16, wherein the display controller is configured to identify the most recent tile based on the GPU providing an indication to the display controller when new tiles have been written into the plurality of framebuffers.

18. A method comprising:
reading a first tile of image data of a first tile row into image processing circuitry for display on an electronic display; and
reading a second tile of the first tile row next to the first tile of image data into the image processing circuitry for display on the electronic display, wherein the first tile and the second tile correspond to different frames but are displayed on the electronic display at the same time.

19. The method of claim 18, wherein the second tile is read in raster order after the first tile.

20. A method comprising:
generating tiles of image data corresponding to image frames in a first order; and
displaying the tiles of image data corresponding to the image frames in a second order, wherein a row of tiles of image data displayed on an electronic display comprises a first tile corresponding to a first frame of the image frames and a second tile corresponding to a second frame of the image frames.

21. The method of claim 20, wherein the second order is a raster order and the first order is not a raster order.

22. The method of claim 21, wherein the first order is an arbitrary order.
